(19) United States
(12) Patent Application Publication
(10) Pub. No.: US 2026/0243138 A1
(43) Pub. Date: Aug. 20, 2026

(54) A SCREEN ASSEMBLY FOR USE IN A SHALE SHAKER

(71) Applicant: Rollman Holding B.V., Noordscheschut (NL)

(72) Inventor: Niek Rollman, Tiendeveen (NL)

(73) Assignee: Rollman Holding B.V., Noordscheschu (NL)

(21) Appl. No.: 19/161,309

(22) PCT Filed: Feb. 29, 2024
(86) PCT No.: PCT/NL2024/050095

§ 371 Date: Sep. 2, 2025

(30) Foreign Application Priority Data
Mar. 3, 2023 (NL) 2034261

(51) Int. Cl. E21B 21/06; B01D 33/03

(52) U.S. Cl. CPC E21B 21/065; B01D 33/0376; B01D 2201/4069

(57) ABSTRACT

A screen assembly for use in a shale shaker is disclosed. The screen assembly is configured to separate solid material out of a solid-liquid mixture and is configured to be releasably fixed in the shale shaker. Further, the screen assembly comprises a support frame and a screen element. The screen element comprises a screen surface that is configured to support the solid-liquid mixture. The screen surface comprises one or more filter elements that are permeable to liquid out of the solid-liquid mixture so that the liquid can pass through the screen surface and through the screen element, and that are impermeable to the solid material. The screen surface is a substantially straight surface and the support frame and the screen element are releasably attached to each other by means of one or more magnets.

### FIELD OF THE INVENTION

This disclosure relates to a screen assembly for use in a shale shaker, in particular to such screen assembly wherein a support frame and screen element are releasably attached to each other by means of one or more magnets. This disclosure further relates to respectively a screen system, a support frame, and a screen element for use in the screen assembly as well as to a shale shaker having installed therein a screen assembly disclosed herein.

### BACKGROUND

Shale shakers are well-known in many fields, such as coal cleaning, mining, oil and gas drilling. Shale shakers are configured to separate solid material out of a solid-liquid mixture. To illustrate, when a hole is drilled deep into the ground, drilling fluids are used to lubricate and cool the drill bit and to transport drilled cuttings out of the hole. Thus, the drill fluid that comes out of the hole contains solids, such as the stones and metal parts. These are typically filtered out of the drill fluid by using shale shakers, so that the drill fluid can be reused again, e.g. can be conveyed back into the hole again so that it can perform its lubrication and cooling function again.

When in use, shale shakers comprise one or more screens that are shaken by a vibrator. The solid-liquid mixture moves over the screens, which screens allow fluid to pass through, while blocking solid materials of a certain size, which size depends on the mesh size of the screens.

In most shale shakers, the screens are releasably fixed in the shale shaker when the shale shaker is in use. The screens can then be quite easily replaced when necessary, e.g. when 15% of the screen area is damaged. Unfortunately, the screens typically do not qualify for disposal as recyclable waste, but should be disposed as residual waste. This is due to the materials that are typically used (composite materials) or the weight of the screens. Even if recycling would be possible, than that is typically not an economically viable option, because of high transportation costs.

WO 03/013690 A1 discloses a screen system suitable for use in a vibratory screen apparatus. The screen system comprises a screen element and a support frame. The screen element consists essentially of a mesh panel provided with first and second elongate support members extending along opposite end portions of the mesh panel. The support frame has spaced apart first and second elongate frame elements for engagement with the screen element support members and further elongate frame elements extending there between for supporting the mesh panel. The screen element support members and said first and second frame elements are formed and arranged for secure interengagement in use of the screen system, with at least one of said screen element support members and the respective one of said first and second frame elements being formed and arranged so that when clamped together, the mesh panel is securely held under tension against said further frame elements. WO 03/013690 A1 describes that an advantage of this screen system is that the screen element can have a particularly simple and economical construction which can be treated as disposable, while the necessary rigidity and support for the screen element, in use of the screen system, can be provided by means of the support frame which can readily be reused with successive replacement screen elements.

This disclosure aims to provide a screen system in which a screen element and support frame can be releasably attached to each other, that allows for more efficient material usage.

### SUMMARY

To that end, a screen assembly for use in a shale shaker is disclosed. The screen assembly is configured to separate solid material out of a solid-liquid mixture and is configured to be releasably fixed in the shale shaker. Further, the screen assembly comprises a support frame and a screen element. The screen element comprises a screen surface that is configured to support the solid-liquid mixture. The screen surface comprises one or more filter elements that are permeable to liquid out of the solid-liquid mixture so that the liquid can pass through the screen surface and through the screen element, and that are impermeable to the solid material. The screen surface is a substantially straight surface and the support frame and the screen element are releasably attached to each other by means of one or more magnets.

This screen assembly is advantageous in that the screen element and the support frame are releasably attached to each other. Hence, once the screen element, in particular the screen surface, has been worn out because of the intensive use in the shale shaker, the screen assembly can be taken out, and the worn out screen element can be replaced by a new one. The support frame, which may be understood to provide rigidity to the screen assembly, can be re-used over and over again, while the used screen element can be disposed of separately or even be restored so that it can be used again. As a side note, restoring the screen element may involve replacing a mesh forming the filter elements on the screen surface. In any case, during a (e.g. mining/drilling) project, the support frame can remain at the location of the shale shaker, and only “fresh” screen elements need to be transported to, and stored at, the location of the shale shaker. It is readily understood that screen elements can be made relatively light-weight and thin, which is highly convenient for transport and storage.

The mesh panel of the screen system of WO 03/013690 A1 is curved due to it being held under tension against the support frame. The tension aids to prevent the mesh panel from rattling against the support frame when it is being heavily vibrated in the shale shaker. Such rattling would be highly undesired as it may damage the mesh panel and/or support frame or at least significantly shorten the life span of the mesh panel. The mesh panel's curvature, however, causes the solid-liquid mixture, when it passes over the mesh panel, to move away from the higher centre area and pass, to a greater extent, over the lower areas at the sides of the mesh panel. Not only does this phenomenon lower the screening capacity of the mesh panel-after all, the screening capacity at the centre area is not fully used-it also causes the mesh panel to wear out faster at the side areas than at the centre area.

Once the side areas of the mesh panel are damaged to such extent that the mesh panel has to be replaced, the mesh material in the centre area of the mesh panel is likely still in good condition. In such case, the mesh material in the centre area is not fully used, which constitutes inefficient material usage.

In contrast, the screen element of the screen assembly disclosed herein has a substantially straight screen surface. Hence, the solid-liquid mixture, which may be a drilling fluid mixture, passes relatively evenly over the screen surface. The screen surface of the screen element disclosed herein thus wears out more evenly, which constitutes a more efficient material usage. The one or more magnets may be understood to attach the support frame and screen element to each other such that the screen element, in particular the screen surface, does not rattle against the support frame when the screen assembly is being used in an operational shale shaker. Due to the magnets, the screen surface does not need to be held under tension against the support frame. Such tension may be impossible to achieve given that the screen surface is straight. In that sense, the one or more magnets may be understood to enable implementation of a straight screen surface in a screen system having support frame and screen element that are separable from each other.

The one or more magnets allow the support frame and the screen element to be easily separable, for example without having to unfasten any bolts or screws. Preferably, the support frame and the screen element can be separated by hand. The one or more magnets obviate the need to implement fastening means with movable parts, such as screws and bolts. Shale shakers, in particular the vibrational motors of the shale shakers, typically cause accelerations of the screens as high as 5-8 g. To add to this, shale shakers are typically in operation 24 hours per day, 7 days per week. Movable parts are typically not resistant against such continuous, strong vibrations in that they break or come loose.

As referred to herein, a screen assembly being releasably fixable in a shale shaker may be understood as that the screen assembly can be inserted into and taken out of the shale shaker without damaging the shale shaker or screen assembly. Preferably, the screen assembly can be inserted into and taken out of the shale shaker as a unit.

The support frame may be embodied as a unit. Additionally or alternatively, the screen element may be embodied as a unit. Further, the support frame and screen element may have substantially equal dimensions as viewed in a direction perpendicular to the screen surface and/or may substantially have equal length and equal width.

As referred to herein, two elements being releasably attached to each other may be understood as that the two elements can be separated without damaging either of them.

As referred to herein, a straight surface may be understood as an uncurved surface. Preferably, the screen surface is relatively flat as well in the sense that it does not have any protrusions or recesses behind which or in which solid material passing over the screen surface can get stuck.

All areas on the screen element over which the solid-liquid mixture can pass when the screen assembly is being used in an operational shale shaker, may be understood to belong to the screen surface.

Preferably, the one or more magnets are one or more permanent magnets. This conveniently obviates the need to provide an electric current to the magnets.

In an embodiment, the screen element is shaped as a plate, preferably as a rectangular plate. Such plate-shaped screen elements can be easily stacked, and thus occupy limited space when in transport or in storage. Further, due to the plate shape the screen element can be attached to the support frame quite easily. The screen element can be simply placed on the support frame without having to operate complex clamping or locking mechanism, for example.

In an embodiment wherein the screen element is shaped as a plate, the support frame preferably comprises a plurality of level top surfaces, which may be understood as surfaces of the support frame facing the screen element, so that a bottom surface of the screen element sits flush against the top surfaces of the support frame.

In an embodiment, the screen element has a length extending in a first direction, a width extending in a second direction and a thickness extending in a third direction, wherein the thickness is less than 1 centimeter, preferably less than 7 millimeters, more preferably less than 5 millimeters.

In this embodiment, the screen element is relatively thin, which is beneficial for storage and transport, but also enables to limit the weight of the screen element which, in turn, limits the size and/or number and/or strength of the one or more magnets that are used.

Preferably, the first direction, second direction and third direction are the three orthogonal directions of a Cartesian coordinate system.

In an embodiment, the screen element weighs between 1 and 3 kilograms. The limited weight of the screen element is beneficial for the transportation and handling of the screen elements, and also relaxes the requirements for the one or more magnets as stated above.

In an embodiment, the screen element comprises a base element having one or more apertures and a mesh screen that is held under tension by a coating, preferably a thermoplastic coating, provided on the base element. Herein, the mesh screen covers the one or more apertures and herewith forms the one or more filter elements at the one or more apertures.

Additionally or alternatively, the mesh screen may be glued to the base element. Additionally or alternatively, the mesh screen may be secured to the base element by mechanical means, such as clamps.

The screen element may be of the so-called pretensioned type, meaning that the tensioning of the mesh screen has already been performed during fabrication of the screen element as opposed to hook strip screens, for example.

The base element may be a steel plate with one or more apertures. The steel plate is for example made out of cold rolled steel.

In an embodiment, the support frame comprises a first side beam, and a second side beam that is parallel to the first side beam, and a first crossbeam, a second crossbeam and a third crossbeam. Each of the first crossbeam, second crossbeam and third crossbeam extends between the first side beam and the second side beam.

In such embodiment, each beam may have a top surface, which may be understood as the surface of the beam facing the screen element. Preferably, the top surfaces of the respective beams are level with each other, so that a bottom side of the plate-shaped screen element sits flush against all top surfaces. This is advantageous, because any magnet inside of a beam near the beam's top surface will sit close to the screen element, in particular to any ferromagnetic elements thereof, so that the magnet strongly attracts the screen element, in particular the screen element's ferromagnetic element.

Of course, the support frame may comprises more than three crossbeams extending between the first side beam and the second side beam, for example four or five cross beams.

Preferably, the first cross beam is connected to the first side beam at a first end of the first side beam and connected to the second side beam at a first end of the second side beam and the second cross beam is connected to the first side beam at a second end of the of the first side beam and connected to the second side beam at a second end of the second side beam. In such case, if the cross beams are perpendicular to the side beams, the first side beam, second side beam, first cross beam and second cross beam may form a substantially rectangular support frame. Preferably, the third crossbeam is connected to the first side beam somewhere between the first end and second end of the first side beam, more preferably halfway the first and second end of the first side beam, and connected to the second side beam somewhere between the first end and second end of the second side beam, more preferably halfway the first and second end of the second side beam.

Any beam referred to in this disclosure may be a steel beam. Beams are for example connected to each other in the sense that they have been welded together.

In an embodiment, the second crossbeam comprises the one or more magnets, preferably in its interior. Preferably the second crossbeam is positioned between the first crossbeam and second crossbeam.

In an embodiment, the support frame weighs between 3 and 6 kilograms.

In an embodiment, the support frame comprises the one or more magnets and the screen element comprises one or more ferromagnetic elements. The one or more magnets may sit in the interior of one or more beams, e.g. in the interior of one or more crossbeams referred to herein.

Preferably, each of the one or more magnets sits close to a corresponding ferromagnetic element out of the one or more ferromagnetic elements of the screen element.

In case the screen element comprises as base element a steel plate with apertures, then the steel plate as a whole may be understood to be the ferromagnetic element. In an embodiment, the steel plate is made out of cold rolled steel.

In an embodiment, as viewed in a direction perpendicular to the screen surface, the one or more magnets are present in a central area of the screen assembly. This embodiment ensures that the screen element and support frame experience an attractive magnetic force specifically in the central area. The central area is where the screen element and the support frame are typically not clamped together when the screen assembly is being used in an operational shale shaker. Therefore, at the central area the risk of the screen element rattling against the support frame due to the high accelerations is highest.

Preferably, as viewed in a direction perpendicular to the screen surface, the one or more magnets are present in a central area of the screen element when the screen element is attached to the support frame. This may be achieved by placing the one or more magnets in and/or on the support frame such that they are, as viewed from the direction perpendicular to the screen surface, positioned in a central area of the screen element when the screen element is attached to the support frame.

As viewed in the direction perpendicular to the screen surface, the central area may be understood to be formed by all points that lie closer to the geometric center of the screen assembly shape than to any outer edge of the screen assembly shape.

The shale shaker may be configured to clamp the screen assembly at a first side of the screen assembly, for example at the first side beam mentioned above, and at a second side of the screen assembly, for example at the second side beam mentioned above, and not at any other sides of the screen assembly. In such case, the central area, as viewed in the direction perpendicular to the screen surface, may additionally or alternatively be understood to be formed by all points that lie closer to a halfway line than to either of the first or second side, wherein the halfway line sits halfway between the first side and the second side. In a preferred embodiment, the one or more magnets sit at least at the halfway line.

More generally speaking, the shale shaker may be configured to clamp the screen assembly at a first part of the screen assembly and at a second part of the screen assembly, wherein the one or more magnets sit in a central part of the screen assembly, the central part being between the first part and the second part of the screen assembly. The central part may be understood to be formed by all points of the screen assembly that are closer to a halfway line of the screen assembly than to either of the first and second part, the halfway line being halfway between the first part and the second part.

The shale shaker may be configured to press the screen element and support frame onto each other at the first part and at the second part.

Preferably, the first and second part are, as viewed in the direction perpendicular to the screen surface, at opposite sides of the screen assembly.

In an embodiment, each magnet of the one or more magnets has a pull strength of at least 5 kilograms, preferably at least 6 kilograms.

The pull strength is the highest possible holding power of a magnet measured in kilograms. It is the force required to prise a magnet away from a flat steel surface when the magnet and metal have full and direct surface-to-surface contact.

One aspect of this disclosure relates to a screen system that is configured to be assembled to form a screen assembly for use in a shale shaker, wherein the screen assembly is configured to separate solid material out of a solid-liquid mixture and is configured to be releasably fixed in the shale shaker, the screen system comprising a support frame, and a screen element comprising a screen surface that is configured to support the solid-liquid mixture, the screen surface comprising one or more filter elements that are permeable to liquid out of the solid-liquid mixture so that the liquid can pass through the screen surface and through the screen element, and that are impermeable to the solid material, wherein the screen surface is a substantially straight surface, and wherein the support frame and the screen element are releasably attachable to each other by means of one or more magnets.

One aspect of this disclosure relates to a screen element for use in any of the screen assemblies disclosed herein. This screen element may be any of the screen elements described herein.

One aspect of this disclosure relates to a support frame for use in any of the screen assemblies disclosed herein. This support frame may be any of the support frames disclosed herein.

One aspect of this disclosure relates to a shale shaker having installed therein any of the screen assemblies disclosed herein. Preferably, this shale shaker comprises a clamping mechanism that clamps the screen assembly at a first side of the screen assembly and at a second side of the screen assembly opposite the first side, herewith pressing, at the first and second side, the support frame and screen element onto each other and herewith securing the screen assembly to the shale shaker.

Preferably, the first and second side are, as viewed in a direction perpendicular to the screen surface, at opposite sides of the screen assembly.

A distinct aspect of this disclosure relates to a screen assembly for use in a shale shaker. This screen assembly is configured to separate solid material out of a solid-liquid mixture and is configured to be releasably fixed in the shale shaker. Further, this screen assembly comprises a support frame and a screen element. The screen element comprises a screen surface that is configured to support the solid-liquid mixture. The screen surface comprises one or more filter elements that are permeable to liquid out of the solid-liquid mixture so that the liquid can pass through the screen surface and through the screen element, and that are impermeable to the solid material. The support frame and the screen element are releasably attached to each other by means of one or more magnets. Thus, in this screen assembly, the screen surface is not necessarily a substantially straight surface. It should be appreciated that the screen element and support frame of this screen assembly can be any of the screen elements resp. support frames as described herein.

Elements and aspects discussed for or in relation with a particular embodiment may be suitably combined with elements and aspects of other embodiments, unless explicitly stated otherwise.

### BRIEF DESCRIPTION OF THE DRAWINGS

Aspects of the invention will be explained in greater detail by reference to exemplary embodiments shown in the drawings, in which:

FIG. 1 illustrates a shale shaker according to an embodiment;

FIG. 2 illustrates a screen system according to an embodiment, that is configured to be assembled into a screen assembly;

FIG. 3 illustrates a screen assembly according to an embodiment;

FIG. 4 shows a top view, side views and cross sections of a screen assembly according to an embodiment;

FIG. 5 illustrates a base element of a screen element according to an embodiment;

FIG. 6 illustrates a screen element according to an embodiment;

FIG. 7 illustrates a detail of a screen element according to an embodiment;

FIG. 8 illustrates a support frame according to an embodiment;

FIG. 9 shows a top view and side views of a support frame according to an embodiment;

FIG. 10 illustrates a shale shaker according to an embodiment;

FIG. 11 shows a top view of a support frame according to an embodiment;

FIG. 12 shows a top view of a support frame according to an embodiment.

### DETAILED DESCRIPTION OF THE DRAWINGS

In the figures, identical reference numbers indicate identical or similar elements.

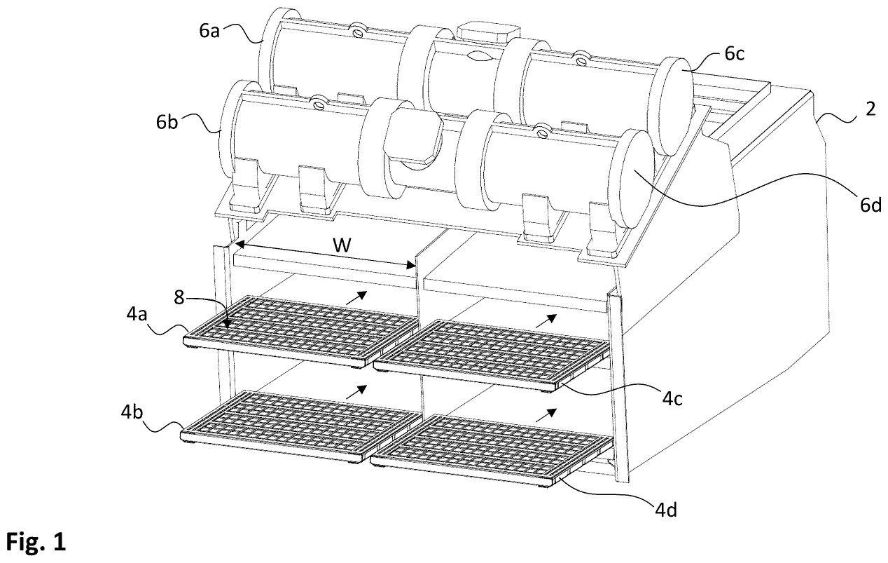

FIG. 1 illustrates how screen assemblies 4a, 4b, 4c, 4d according to an embodiment may be inserted into a shale shaker 2. The screen assemblies 4 may be slid in the direction of the arrows into the shale shaker 2. To this end, the shale shaker 2 preferably comprises screen assembly guiding elements, such as inwardly projecting flanges as described and shown in WO03/013690 A1, that are configured to support the screen assemblies 4 in the shale shaker 2 and guide the screen assemblies to their correct positions in the shale shaker 2.

The shale shaker 2 may in principle be any shale shaker known in the art. FIG. 1 for example indicates a plurality of vibrators 6a, 6b, 6c, 6d that are configured to strongly vibrate the screen assemblies 4 in order to move a solid-liquid mixture over the screen assemblies 4, in particular over their respective screen surfaces 8. The liquid out of the solid-liquid mixture can then pass through the filter elements that will be described in more detail below while solid material cannot. Hence, the screen assemblies 4 separate solid material out of the solid-liquid mixture. A shale shaker 2 is for example configured to receive drilling fluid waste from a receiving pit and to separate solids from the drilling fluid waste to produce a separated drilling fluid waste.

Typically, finer solids that pass through the higher positioned screen assemblies 4a and 4c fall on the screen assemblies below them, i.e. on screen assemblies 4b and 4d. These lower positioned screen assemblies 4b, 4d can typically separate finer solids out of the solid-liquid mixture then the higher positioned screen assemblies.

A shale shaker 2 typically comprises, for each screen assembly that it can accommodate, a clamping mechanism that can fixate the screen assembly in the shale shaker 2. Preferably, such clamping mechanism is configured to clamp a screen assembly at a first side of the screen assembly and at a second side of the screen assembly opposite the first side so that the screen element of the screen assembly and the support frame are pressed onto each other. As a result, the screen assembly 4 as a whole can be secured to the shale shaker 2.

A clamping mechanism referred to herein may be a clamping mechanism as described in WO03/013690 A1 and/or GB2176424 A1 and/or GB2176425 A1. The clamping mechanism may comprise a collapsible tube that can be filled with pressurized fluid, such as compressed air or a liquid, such as water or hydraulic fluid, in order to secure a screen assembly 4 according to an embodiment to the shale shaker 2. Additionally or alternatively, the clamping mechanism comprises one or more wedges that are configured to secure the screen assembly in the shale shaker.

Each screen assembly 4 is releasably fixed in the shale shaker. For example, once a screen assembly 4 is worn out and ready to be replaced, the clamping mechanism can be controlled to cease clamping the screen assembly 4. Then, the screen assembly 4 can be taken out of the shale shaker 2 again, for example by simply pulling on the screen assembly 4 in a direction opposite the arrows shown in FIG. 1.

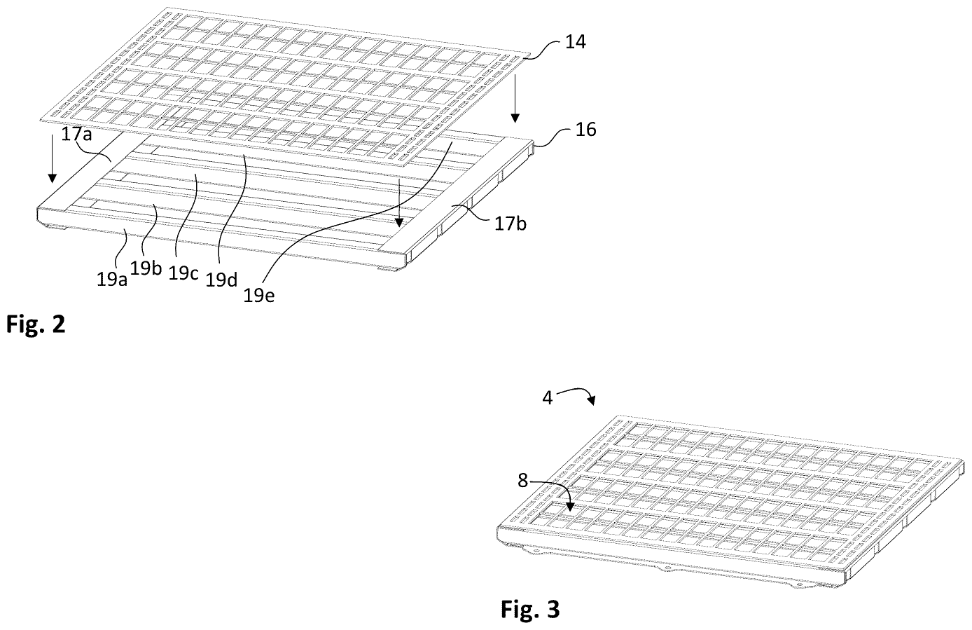

FIGS. 2 and 3 illustrate how the screen assembly 4 may be assembled. FIG. 2 shows the screen element 14 and support frame 16 in disassembled state. As indicated by the arrows, the screen element 14 can be positioned onto the support frame 16. Due to one or more magnets, that are for example positioned inside of the support frame 16 (not shown), the support frame 16 and the screen element 14, which preferably comprises a metal body plate, attach to each other.

The support frame 16 comprises a first side beam 17a, second side beam 17b, and five crossbeams 19a, 19b, 19c, 19d, 19d. Preferably, all these beams are made of steel, preferably stainless steel, such as stainless steel SAE 304 or stainless steel SAE 316, and are welded together. Additionally or alternatively, some or all of these beams are made of aluminum.

In the embodiment shown, the screen surface 8 is a substantially straight surface 8 and the screen element 14 is shaped as a plate. The latter may be understood as that the screen element 14 is nowhere thicker than 1 centimeter, preferably as that the screen element 14 is nowhere thicker than 7 millimeter, more preferably as that the screen element 14 is nowhere thicker than 5 millimeter. In the shown embodiment, the screen element has a thickness of 3 mm.

The screen element 14 being shaped as a plate enables to use common clamping mechanisms that are also used for screens known in the art. No complex locking mechanisms are required that lock the screen element 14 to the support frame 16.

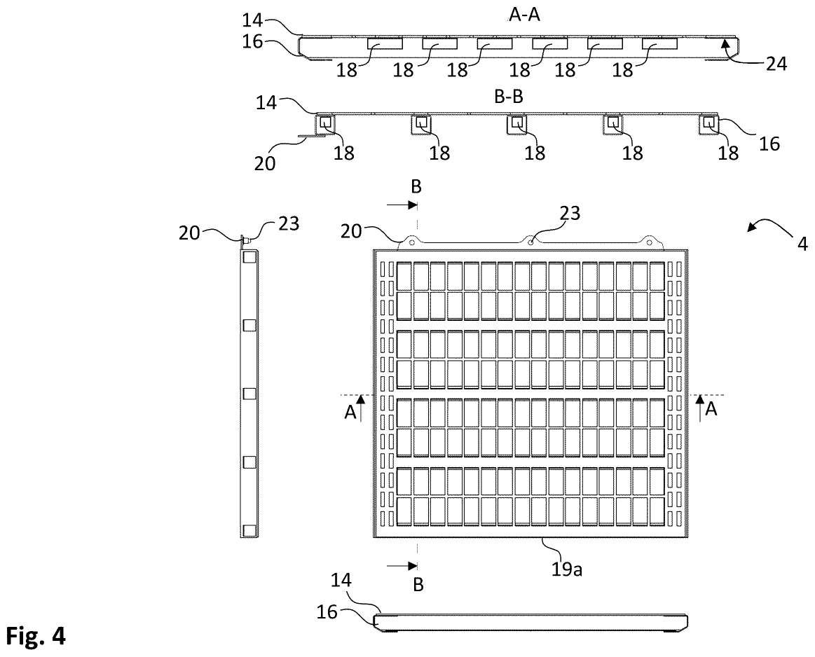

FIG. 4 shows a top view of a screen assembly 4 according to an embodiment, as well as a side view, front view and two cross sections along line A-A and line B-B respectively indicated in the top view.

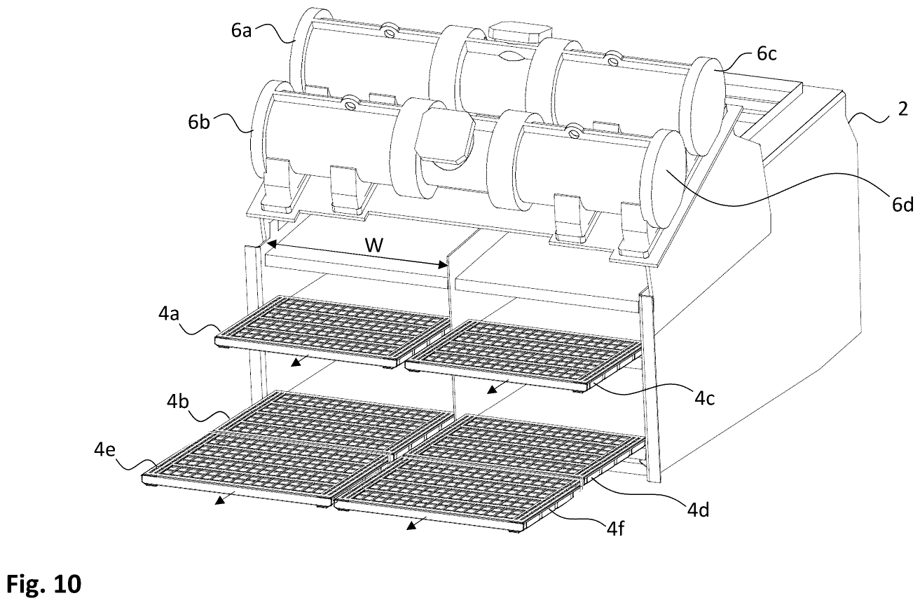

As can be seen in the top view, the shown screen assembly 4, in particular the support frame 16 comprises a protruding tongue 20. The protruding tongue 20 comprises one or more protrusions 23. These protrusions can fit in corresponding apertures (not visible) on the bottom side of cross beam 19a of another copy of the screen assembly. In this manner, multiple screen assemblies can be attached to each other (as shown in FIG. 10) which eases the removal of the screen assemblies that are furthest inserted into the shale shaker.

The cross sections A-A and B-B illustrate that the frame structure 16 accommodates a plurality of permanent magnets 18. In the depicted embodiment, the magnets 18 are present on the inside of the cross beams 17, in particular near and/or on the inner surface 24 that sits opposite the outer surface 26 (see FIG. 9) that contacts the screen element 14 when the screen assembly 4 is in assembled state.

The magnets may be held in place inside the cross beams 16 by filler material (not shown). Such filler material at least partially occupies the inside of the cross beam and is configured to keep the magnets at a fixed position within the cross beam 17. Preferably, the magnets are then fixed to the filler material. Preferably, the magnets are at least partially embedded in the filler material as well. In a particular example, the filler material is a bar shaped piece of rubber to which a plurality of magnets are fixed, e.g. glued. By sliding the bar shaped piece of rubber, with the magnets fixed thereto and preferably embedded therein, into the cross beam 17, the magnets are positioned in the cross beam 17 and kept in place. Instead of rubber, another material, such as Teflon, could also be used.

Each magnet of the one or more magnets has a pull strength of at least 6 kilograms. In the depicted embodiment, each magnet has a pull strength of 6.4 kilograms. Further, in the depicted embodiment, the support frame comprises 30 magnets (6 magnets per cross beam) each having pull strength of 6.4 kilograms. However, more or less than 30 magnets may be used, for example 35 magnets.

The one or more magnets may in principle have various shapes. For example, the one or more magnets may be shaped as a cube, cylinder, rectangular cuboid, et cetera.

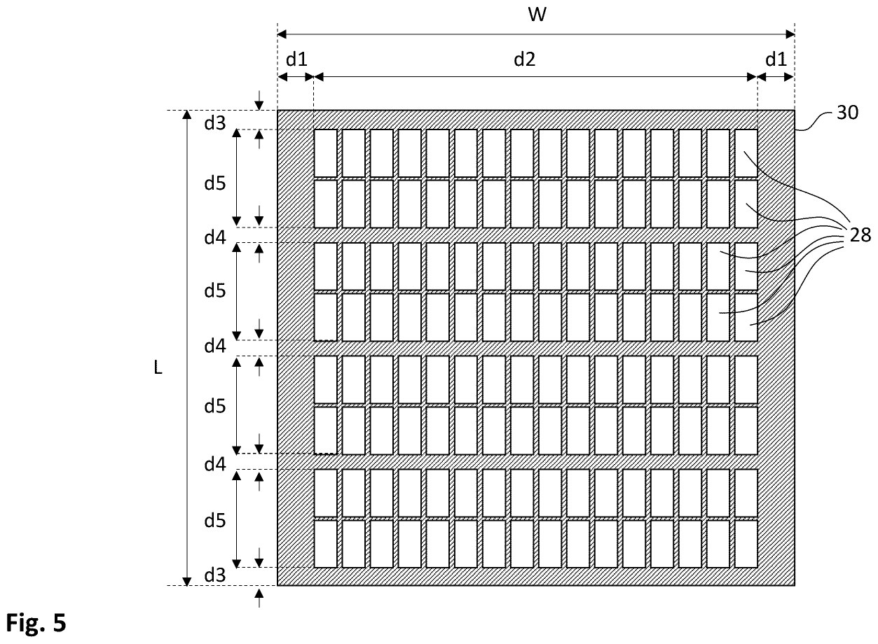

FIG. 5 illustrates a base element 30, in this case a plate, preferably a steel plate, of a screen element 14 according to an embodiment. Advantageously, the steel plate is attracted by magnetic forces as for example caused by one or more permanent magnets comprised in the support frame 16. Hence, the base element 30 may be the ferromagnetic element referred to herein of a screen element 14. The plate 30 comprises a plurality of apertures 28. These apertures 28 may have any shape, in principle.

The width W of the plate 30 is preferably such that the screen assembly can be inserted properly in a shale shaker 2. In an embodiment, the width W of the base element 30 is equal to the width of the basket of the shale shaker 2 into which the screen assembly is to be inserted as indicated in FIG. 1.

The width W is for example between 60 and 70 centimeters. The length L is for example between 55 and 65 centimeters. d1 is for example between 4 and 5 centimeters. In this embodiment, d2 is given by d2=W−2*d1. d3 is for example between 1 and 3 centimeters. d4 is for example between 1 and 3 centimeters. d5 is for example between 10 and 15 centimeters.

It should be appreciated that the exact measures are determined by the shale shaker that is used. To illustrate, there are shale shakers in which screen assemblies having a width W of 125 cm and a length L of 80 cm should be placed.

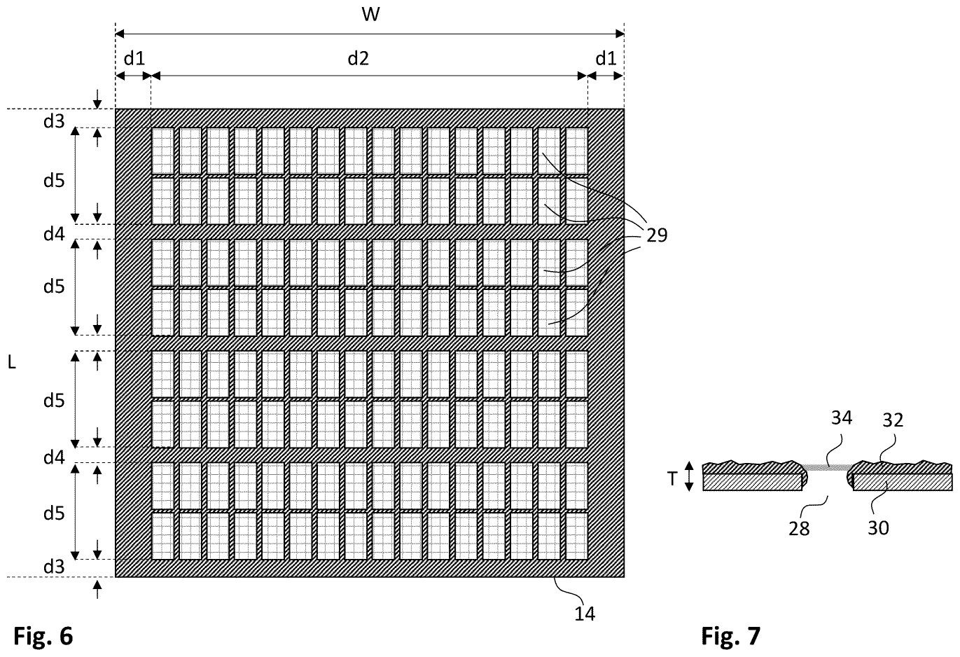

FIG. 6 illustrates a screen element 14 according to an embodiment. The screen element comprises the base element 30 as shown in FIG. 5. Further, since FIG. 6 shows a top view of screen element 14, it essentially shows the screen surface 8 over which the solid-liquid mixture passes when the screen assembly 14 is being used in a shale shaker 2. The screen surface 8 comprises a plurality of filter elements 29. In the depicted embodiment, the filter elements 29 are formed by a tensioned screen mesh 34 that is positioned over the apertures 28 of the base element 30, wherein the tensioned screen mesh 34 is held in place by a coating 32.

The screen mesh 34 is permeable to liquid out of the solid-liquid mixture so that the liquid can pass through it and therefore through the apertures 28, thus through the screen surface, and thus through the screen element 14. Further, the screen mesh 34 is impermeable to solid material out of the solid-liquid mixture. Of course, depending on the size of the meshes, different sized solids can pass through. Typically, the screen meshes of screen assemblies that are positioned higher in the shale shaker, e.g. screen assemblies 4a and 4c shown in FIG. 1, have a larger mesh size than the screen meshes of screen assemblies that are positioned lower in the shale shaker, e.g. screen assemblies 4b and 4d shown in FIG. 1.

The screen element 14 has substantially the same width W and length L as the base element 30. The thickness T of the screen element 14 is indicated in FIG. 7 (bottom). This thickness T is preferably less than 1 centimeter, preferably less than 7 millimeters, more preferably less than 5 millimeters.

The screen element weighs between 6 and 9 kilograms.

FIG. 7 schematically illustrates how the screen mesh 34 can be fixated in a coating 32, preferably a thermoplastic coating, provided on the base element 30. The screen mesh 34 covers the apertures 28 of the base element 30 and is kept under tension by the coating 32.

T indicates a thickness of the screen element.

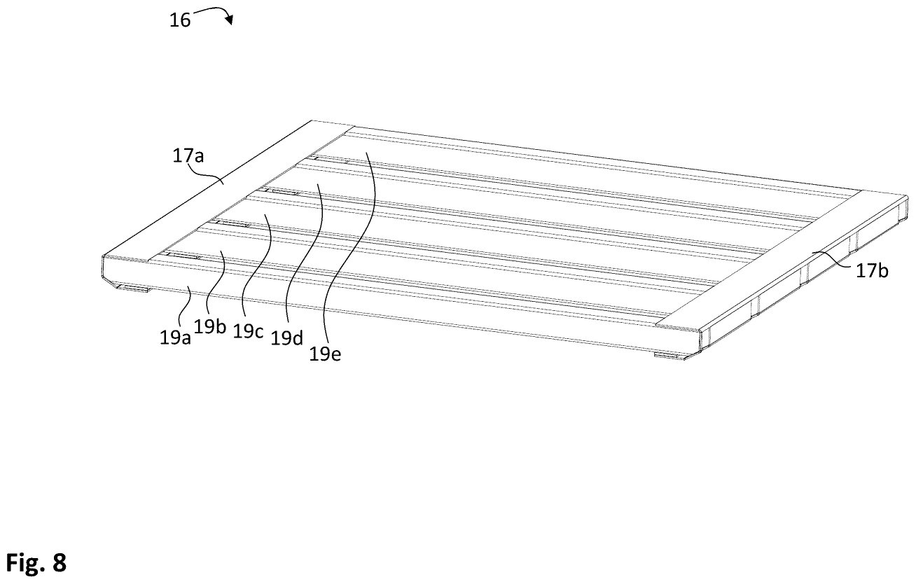

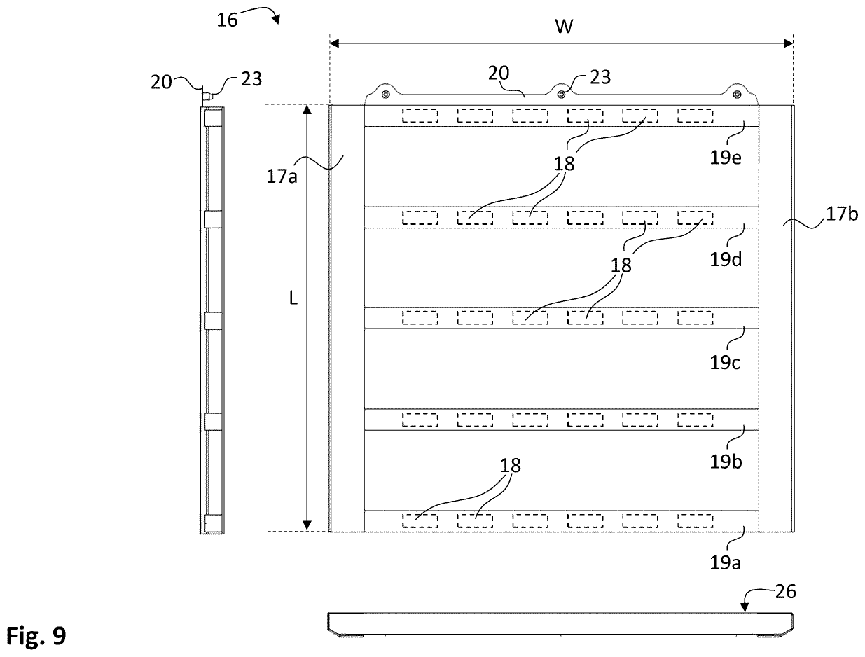

FIG. 8 shows a support frame 16 according to an embodiment. In this embodiment, the support frame 16 comprises a first side beam 17a, and a second side beam 17b that is parallel to the first side beam, and a plurality of crossbeams 19a, 19b, 19c, 19d, 19e, each of which extends between the first side beam 17a and the second side beam 17b. The side beams may be parallel to each other. The crossbeams may also be parallel to each other. The side beams may be orthogonal to the cross beams.

The support frame 16 is preferably rigid so that it provides the required rigidity and support for the screen element 14.

The support frame weighs between 3 and 6 kilograms.

FIG. 9 shows a top view, side view and front view of the support frame 16 according to an embodiment. The dashed rectangles indicate the positions of the magnets 18 inside of the support frame 16.

The frame has a width W that is preferably equal to the width W of the of the screen element (see FIG. 6) and a length L that is preferably equal to the length L of the screen element (see FIG. 6) so that the screen element 14 nicely fits onto the support frame 16.

In the embodiment of FIG. 9, the support frame 16 comprises a protruding tongue 20 that itself comprises one or more protrusions 23. In the depicted embodiment, as an example, the protrusions 23 are one or more pins. The protrusions 23 can engage a side beam of support frame of another screen assembly in order to connect the two screen assemblies to each other.

To illustrate, side beam 19 may comprise apertures on its bottom side (not shown). Then, two copies of the support frame can engage with each other in that the protrusions 23 of one support frame can be inserted in the holes on the bottom side of side beam 19 of the other support structure. Such connection is advantageous in that it eases inserting into and especially taking out of a shale shaker several screen assemblies that are positioned in the shale shaker side by side as illustrated in FIG. 10. In FIG. 10, if screen assembly 4e resp. 4f is pulled out of the shale shaker 2, then screen assembly 4b resp. 4d will follow because of the engagement between screen assemblies 4e and 4b, resp. between screen assemblies 4f and 4d. Thus, there is no need to reach far into the shale shaker 2 to take out screen assemblies 4b and 4d.

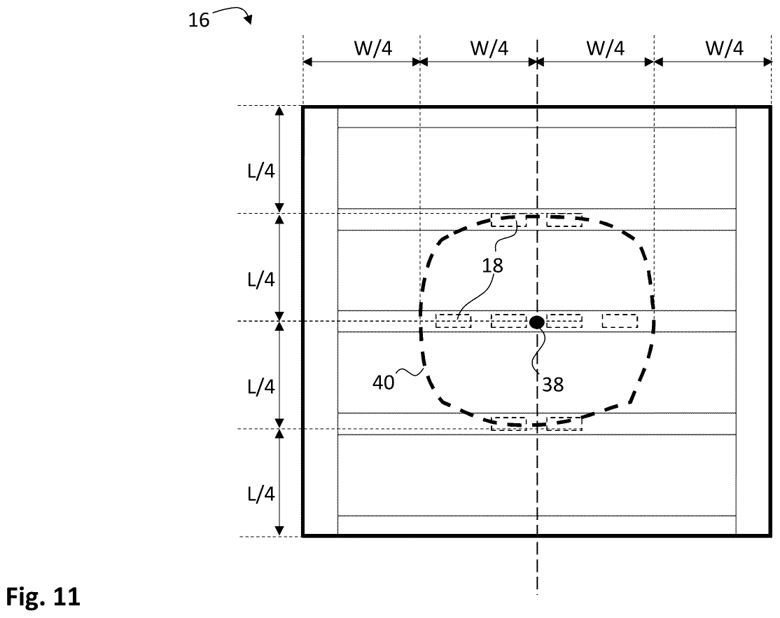

FIG. 11 shows a top view of a support frame 16 according to an embodiment. Herein, a central area of the screen area is marked by thick, dashed line 40. The magnets 18 are preferably present (at least) in this central area 40.

The central area 40 may be understood to be formed by all points that lie closer to the geometric center 38 of the screen assembly shape than to any outer edge of the screen assembly shape. In FIG. 11, the outer edges of the screen assembly shape are indicated by thick lines.

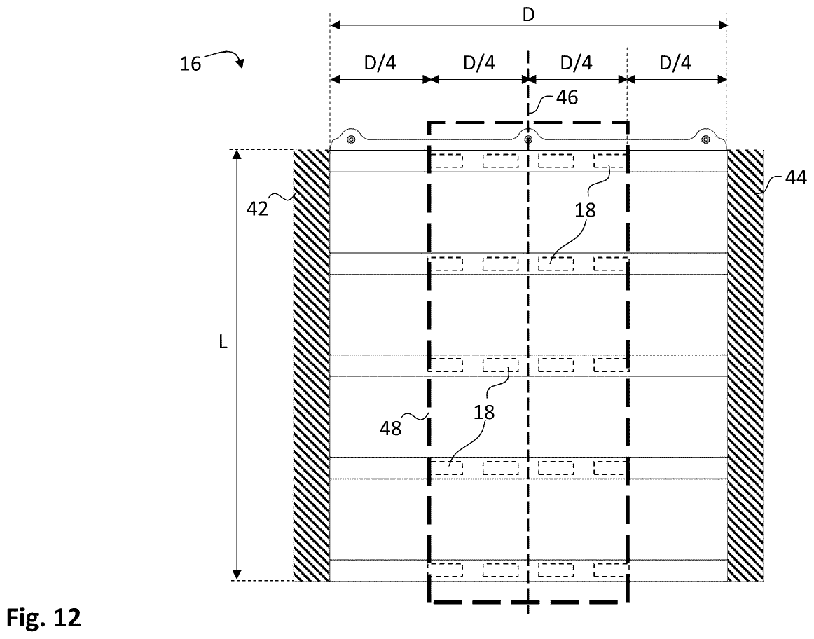

FIG. 12 shows a top view of a support frame 16 according to an embodiment. FIG. 12 also shows a central area 48 indicated by the thick dashed line 48. The magnets 18 are present (at least) in this central area 48.

In this embodiment, when in use, the screen assembly 4 is clamped at a first part 42 of the screen assembly and at a second part 44 of the screen assembly. As described above, an inflatable tube may clamp the screen assembly 14 and support frame 16 together at these parts 42 and 44. The central area 48 sits between these parts.

In the depicted embodiment, a distance D separates the first part 42 and the second part 44 and a halfway line 46 sits halfway between the first part 42 and second part 44. All points of the screen assembly that are closer to this halfway line 46 than to either of the first 42 and second part 44 belong to central area 48. In principle, all other points of the screen assembly lie outside this central area 48.

As explained above, the central area thus sits relatively remote from the parts 42 and 44 that at which the screen assembly is clamped. Hence, especially this area comprises one or more magnets in order to prevent the screen element 14 from rattling against the support frame 16.

What is claimed is:

1. A screen assembly for use in a shale shaker, wherein the screen assembly is configured to separate solid material out of a solid-liquid mixture and is configured to be releasably fixed in the shale shaker, the screen assembly comprising:
a support frame; and
a screen element comprising a screen surface that is configured to support the solid-liquid mixture, the screen surface comprising one or more filter elements that are permeable to liquid out of the solid-liquid mixture so that the liquid can pass through the screen surface and through the screen element, and that are impermeable to the solid material;
wherein the screen surface is a substantially straight surface, and wherein the support frame and the screen element are releasably attached to each other by means of one or more magnets.

2. The screen assembly of according to claim 1, wherein the screen element is shaped as a plate.

3. The screen assembly of claim 1m, preceding claims, wherein the screen element has a length extending in a first direction, a width extending in a second direction and a thickness extending in a third direction, wherein the thickness is less than 1 centimeter.

4. The screen assembly of claim 1, preceding claims, wherein the screen element weighs between 1 and 3 kilograms.

5. The screen assembly of claim 1, wherein the screen element comprises:
a base element having one or more apertures; and
a mesh screen that is held under tension by a coating provided on the base element, the mesh screen covering the one or more apertures herewith forming the one or more filter elements at the one or more apertures.

6. The screen assembly of claim 1, wherein the support frame comprises:
a first side beam;
a second side beam that is parallel to the first side beam; and
a first crossbeam, a second crossbeam and a third crossbeam, each of the first crossbeam, second crossbeam and third crossbeam extending between the first side beam and the second side beam.

7. The screen assembly of claim 1, wherein the support frame weighs between 6 and 9 kilograms.

8. The screen assembly of claim 1, wherein the support frame comprises the one or more magnets and wherein the screen element comprises one or more ferromagnetic elements.

9. The screen assembly of clclaim 1, wherein, as viewed in a direction perpendicular to the screen surface, the one or more magnets are present in a central area of the screen assembly.

10. The screen assembly of claim 1, wherein the shale shaker is configured to clamp the screen assembly at a first part of the screen assembly and at a second part of the screen assembly, wherein the one or more magnets sit in a central part of the screen assembly, the central part being between the first part and the second part of the screen assembly.

11. The screen assembly of claim 1, wherein each magnet of the one or more magnets has a pull strength of at least 5 kilograms.

12. A screen system that is configured to be assembled to form a screen assembly for use in a shale shaker, wherein the screen assembly is configured to separate solid material out of a solid-liquid mixture and is configured to be releasably fixed in the shale shaker, the screen system comprising:
a support frame; and
a screen element comprising a screen surface that is configured to support the solid-liquid mixture, the screen surface comprising one or more filter elements that are permeable to liquid out of the solid-liquid mixture so that the liquid can pass through the screen surface and through the screen element, and that are impermeable to the solid material;
wherein the screen surface is a substantially straight surface, and wherein the support frame and the screen element are releasably attachable to each other by means of one or more magnets.

13. (canceled)

14. (canceled)

15. A shale shaker having installed therein the screen assembly according to claim 1, wherein the shale shaker comprises a clamping mechanism that clamps the screen assembly at a first side of the screen assembly and at a second side of the screen assembly opposite the first side, herewith pressing, at the first and second side, the support frame and screen element onto each other and herewith securing the screen assembly to the shale shaker.

16. The screen assembly of claim 3, wherein the thickness is less than less than 7 millimeters.

17. The screen assembly of claim 16, wherein the thickness is less than 5 millimeters.
